(19) United States
(12) Patent Application Publication
(10) Pub. No.: US 2014/0351924 A1
(43) Pub. Date: Nov. 27, 2014

(54) METHOD AND SYSTEM FOR PROVIDING LIMITED SECURE ACCESS TO SENSITIVE DATA

(71) Applicant: Verizon Patent and Licensing Inc., Basking Ridge, NJ (US)

(72) Inventor: Alan Myers, Littleton, CO (US)

(73) Assignee: Verizon Patent and Licensing Inc., Basking Ridge, NJ (US)

(21) Appl. No.: 13/898,742

(22) Filed: May 21, 2013

(51) Int. Cl. H04L 29/06

(52) U.S. Cl. CPC H04L 63/0272
USPC 726/15

(57) ABSTRACT

An approach is provided for enabling limited secure access to sensitive data by an authorized requestor. A request is received for access to data maintained at a primary data center of a secure private network from an authorized requestor. A subset of the data is then determined to be transmitted to a secure data store associated with the requestor through a private firewall of the primary data center based on the request type and the authorization of the requestor. Transmission of a subset of the data is then initiated from the secure data store to the requestor in encrypted form.

### BACKGROUND INFORMATION

With the popular use of the Internet and the World Wide Web, handling of sensitive data continues to pose a concern for users and service providers alike when operating in a public, unsecure environment. Such environments are a fervent ground for misuse by hackers, who employ an ever increasing level of sophisticated techniques for accessing sensitive data stores. For example, it has become commonplace for these hackers to steal private information, such as social security numbers, driver's license numbers, calling card numbers, bank account numbers and credit card numbers, to engage in unauthorized or illegal activities; e.g., identity theft. Governmental entities have responded to identity theft by enacting laws requiring businesses that store sensitive data to perform certain steps to ensure a particular level of integrity of the data. For example, a law may require a certain level of encryption or firewall protection, or the law may require that if data is compromised, a keeper of the data store may be required to inform all owners of the compromised data so that they may take appropriate steps such as informing credit bureaus as well as monitor their credit records for fraudulent activity.

A common method of storage of sensitive data involves encrypting the data and storing it in a database of the business (e.g., a primary data center). Thus, data regarding a particular entity, such as a customer, is stored in common facilities, with authorized applications or services (requestors) being permitted to pass through the firewall of the business to access the data. Unfortunately, a hacker wishing to access such data need only figure out how to break into the facility and how to decrypt the data; thus exposing the sensitive data to fraudulent use. For example, if a hacker broke into a telecommunications client's database and managed to obtain a customer's identity and card number, the hacker could fraudulently place calls using the information—resulting in losses for the provider.

Therefore, there is a need for enabling limited secure access to sensitive data by an authorized requestor.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a networked system for enabling limited secure access to sensitive data by an authorized requestor, according to one embodiment;

FIG. 2 is a diagram of the components of a secure data management platform, in accordance with one embodiment;

FIGS. 3A-3C are flowcharts of processes for enabling limited secure access to sensitive data by an authorized requestor, in accordance with various embodiments;

FIG. 4 depicts an exemplary system flow diagram illustrating data flow between a requestor and the secure data management platform for interacting with a primary data center, in accordance with one embodiment;

FIG. 5 is a diagram of a computer system that can be used to implement various embodiments; and

FIG. 6 is a diagram of a chip set that can be used to implement various embodiments.

### DESCRIPTION OF THE PREFERRED EMBODIMENT

A preferred system, method, and software for enabling limited secure access to sensitive data by an authorized requestor is described. In the following description, for the purposes of explanation, numerous specific details are set forth in order to provide a thorough understanding of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

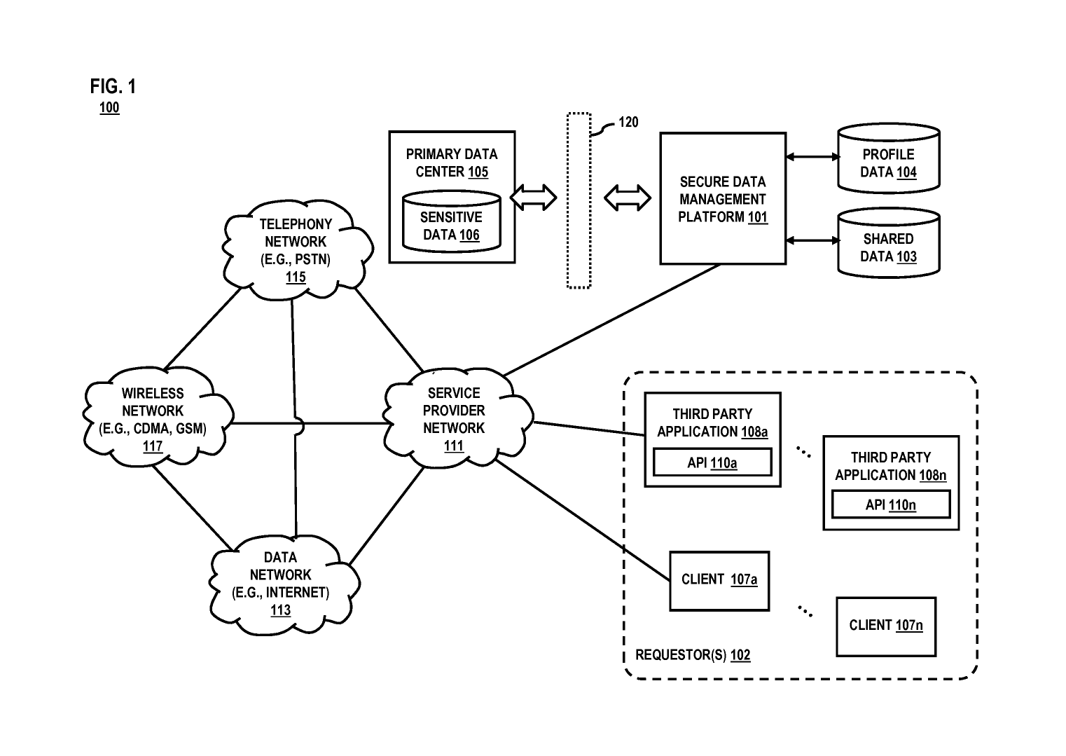

FIG. 1 is a diagram of a networked system for enabling limited secure access to sensitive data by an authorized requestor, according to one embodiment. For the purpose of illustration, system 100 employs a secure data management platform 101 that is configured to provide limited secure access to sensitive data by requestors 102 who are authorized. Platform 101 interfaces with a shared data repository 103, which stores a limited set of sensitive information intended to be shared with said requestors. For the purpose of illustration herein, the shared data repository 103 is used synonymously with “shared data.” Platform 101 also communicates with a profile data repository 104, which may include data for indicating the relationship of a requestor 102 with the provider of a primary data center 105. In addition, the profile data 104 may specify access control information corresponding to the repository of sensitive data 106 as maintained by the primary data center 105. As used herein, the profile data repository 104 is taken to be synonymous with “profile data.” In certain embodiments, the relationship between the requestor 102 and the provider of the primary data center 105 as well as the established access control rights of the requestor 102 may indicate the level of access the requestor 102 may enjoy with respect to the sensitive data 106.

By way of example, the primary data center 105 may be managed by an enterprise, organization or business. As such, the sensitive data 106 may include detailed records regarding customers, vendors, account data, personal data and other sensitive information. This may include financial information (checking or credit card account numbers), governmental data (e.g., a social security number (SSN)), or even private data relating to a service that a user subscribes to (e.g., user profile data, call records, service usage statistics, etc.). As is typical for many enterprises, the primary data center 105 may reside within a private/internal network of the enterprise for security purposes. Still further, the primary data center 105 may be further protected by a dedicated firewall 120. Thus, only authorized applications, services or clients (e.g., requestors 102) are permitted to pass through the firewall 120 and request access to the subject data. The firewall 120 may be implemented according to various known techniques, e.g., via a router or switch, to filter or otherwise block unwanted information at one or more layers (e.g., network layer, application layer, etc.).

As an additional means of security, many networked systems typically require that a look-up key be exchanged via a secure network protocol between the requestor 102 of sensitive data 106, the primary data center 105 and/or an agent/server thereof. In the latter scenario, the agent/server may include a network access point, a scheduling server, or the like that serves as a point of entry to the private network of the enterprise. The look-up key as submitted per a request or as generated may be a secret alpha-numeric string, object, or any other data type capable of being decoded by the primary data center 105 or a requestor (e.g., clients 107a-107n) based on a predefined decryption scheme. One or more look-up key values may be generated by and/or assigned to the requestor 102, depending on the security scheme, for enabling secure access to the sensitive data 106. Accordingly, the ability of the requestor 102 to locate, access, decrypt or retrieve any sensitive information maintained at the primary data center 105 is based on the validity and authenticity of the look-up key value. An improper key value effectively prevents the requestor 102 from accessing the data.

By way of example, in the case where the requestor is a network diagnostic service that is authorized by a telecommunication service provider to collect and subsequently analyze customer network usage or calling information, this information is retrieved upon proper exchange and decrypting of a key value relevant to this transaction. Unfortunately, the diagnostic service may itself be vulnerable to security breaches, thus making it possible for a hacker to pass though the firewall 120, deduce look-up key values or directly retrieve sensitive data 106. As another example, if the hacker broke into the telecommunication service provider's database and managed to obtain customer identity and credit card number data, the hacker could use the data to make authorized charges. Therefore, there is a need for enabling limited secure access to sensitive data by an authorized requestor 102.

To address this issue, the system 100 employs a secure data management platform 101 that facilitates the transmission of sensitive data 106 in response to a request by a requestor 102.

In certain embodiments, the secure data management platform 101 may be implemented as a server, data center or node that resides external to (i.e., outside of) a firewall 120 that protects the primary data center 105. The requestor 102 interacts with the secure data management platform 101 as if it had penetrated the firewall 120 to interact with the primary data center 105 directly. By way of this approach, the secure management platform 101 interacts with the primary data center 105 in response to the request; thus limiting the accessibility of the sensitive data 106 by a requestor 102.

In certain embodiments, the secure management platform 101 submits shared data 103 to the requestor 102 in response to placement of a request for the sensitive data 106. The shared data 103 may or may not correspond to the full set of sensitive data 106 requested by the requestor 102. Rather, the shared data 103 may be a limited or partial set (e.g., subset) of the sensitive data 106 corresponding to the nature or type of request, the level of authority or access of the requestor 102, or a combination thereof. Hence, in certain instances, the secure data management platform 101 enables certain access restrictions to be enforced while still enabling the fulfillment of requests.

The subset of sensitive data 106 capable of being accessed may be determined based on profile data 104 maintained for the requestor 102. For example, the profile data 104 may specify an access level, degree of trust or other credentials of a requestor 102 with respect to resources (e.g., network elements, data sets) of the primary data center 105. As another example, the profile data 104 may include certification information for indicating the relationship of the requestor 102 with the provider of the primary data center 105. Still further, the profile data 104 may specify access control information for indicating specific resource access rights and limitations of the requestor 102 (e.g., which data sets within the sensitive data repository 106 may be accessed, the conditions of access for a given request type, etc.). As such, an incoming request for access to data may be analyzed against the profile data 104 as a means of determining the degree of access a requestor 102 has to the sensitive data 106.

By way of example, when the requestor 102 is an application for querying network usage data regarding business customers of a telecommunication service provider, the profile data 104 may indicate the access rights of the application (as assigned by the provider) as well as any certificate details or look-up key values. Also, per this example, only data regarding network usage may be accessed from the data center 105 of the provider due to the request type, the requestor 102 or other conditions. Hence, other data regarding the customers such as payment information, private settings or other credentials are rendered inaccessible, and thus not retrieved as part of the shared data set with regards to the query request. Still further, while the sensitive data 106 may include data related to all the customers of the provider, including non-business customers and other customer classifications, the subset of data as stored to the shared database repository 103 is limited to only business customers. Hence, as noted previously, per this approach, the amount, type or scope of the sensitive data 106 capable of being accessed is limited to authorized requestors 102 while a limited subset of the sensitive data 106 is conveyed relative to the transaction/request.

In certain embodiments, the requestor 102 may generally be any type of application, service, process, system, device, etc., that may need to store or process any type of sensitive data 106. As such, the requestor 102 may request sensitive data 106 for the purpose of carrying out a particular data-oriented transaction, network task or other execution on behalf of, or in association with, the provider of the primary data center 105. The provider of the primary data center 105 may be any enterprise (e.g., a business or organization) that maintains sensitive data 106 regarding one or more customers, accounts, service transactions, network operations or the like.

By way of example, the requestor 102 may be a client 107a-107n that runs one or more applications 108a-108n for initiating a request procedure—e.g., the client 107 may be a computing device or network node. The applications associated with the clients 107a-107n may be proprietary/trusted applications of the provider of the primary data center 105. In other instances, they may be third party/low trust applications that are employed by the provider of the primary data center 105 for performing specific tasks. Alternatively, the clients 107 may interact with a service associated with the provider of the primary data center 105 via a network 111 for initiating the request procedure.

In certain embodiments, the requestor 102 may employ applications configured with an application programming interface (API) 110a-110n for enabling the fulfillment of requests. The API 110 may execute one or more instructions in connection with the requestor 102, including processes for generating the request for access to the sensitive data 106 with the primary data center 105. For the purpose of illustration herein, the requestor 102 may include the applications 108a-108n, various services, the clients 107a-107n, the application programming interface (API) associated therewith, or a combination thereof.

By way of example, a request may be generated based on a type of transaction to be performed by the requestor 102. Hence, in the exemplary case where the requestor 102 is a billing application employed by a wireline or wireless service provider that maintains the sensitive data 106, the request may query the database 107 for call placement information, account access information, network download rates, etc. As another example, in the case where the requestor 102 is a reporting service of an enterprise for gathering network usage statistics periodically, the request may be for access to information regarding customer activity information. In these examples, the requestor 102 requires access to sensitive data 106; hence, a security mechanism is employed. In certain embodiments, the API 110 generated request specifies a look-up key (key) corresponding to the particular network element, resource and/or data type from which the sensitive data 106 is to be retrieved. In one embodiment, the look-up key may be a string, object or other data value required to be passed and validated for permitting access to the sensitive data 106. It is noted that in certain instances, the key may be required as well to permit transmission of the request through the firewall 120 to the primary data center 105.

In certain embodiments, in response to the request, the authority of the requestor 102 to access the requested sensitive data 106 is authenticated. The criteria for specifying the level of authority or access of the requestor 102 to the sensitive data 106 may be specified according to profile data 104. The profile data 104 may include data regarding the relationship of the requestor 102 to the provider of the primary data center 105, the level of access granted by the requestor 102 to the sensitive data, scheduling or availability restrictions imposed upon the requestor 102 (e.g., time, day, number of requests), etc. In addition, the profile data 104 may maintain certification information regarding the requestor 102, i.e., a digital certificate of authenticity or trust that the requesting entity has access to the primary data center 105 or sensitive data thereof. Still further, the ability of the requestor 102 to receive the shared data 103 may be predicated upon the exchange of appropriate look-up keys for accessing the sensitive data 106 accordingly. As noted, the look-up keys may be specific to particular network elements, segments of the primary data center, etc.

Once authenticated, the secure data management platform 101 operates in connection with the primary data center 105 to encrypt a subset of the sensitive data 106. In one embodiment, the encryption is performed by the secure data management platform 101 in response to direct retrieval of the subset of sensitive data 106. In another embodiment, the encryption may be performed at the primary data center 105 as triggered by the platform 101 per the initial request for access. It is noted that the secure management platform 101 may be adapted to accommodate different network 111 arrangements, firewall 120 and/or security configurations, etc.

In one embodiment, the subset of data as retrieved is limited to that which is pertinent to the request type and/or the requestor 102—i.e., based on profile data 104. This subset of data is then maintained, in encrypted form, by the secure data management platform 101 at the shared database 103. Hence, the secure data management platform 101 may initiate transmission of the encrypted subset of data from the shared data repository 103 to a requestor 102 in response to the initial data request. As such, the platform 101 serves as an intermediary system between the requestor 102 and the primary data center 105, thus preventing direct communication between the two. This is in contrast to a direct interaction communication model, which renders the primary data center 105 more susceptible to attack (e.g., message interception, data redirection) by unwarranted requestors 102.

In certain embodiments, the requestor 102 receives the shared data 103 in response to the request via the shared data repository 103. For example, in the case where the requestor 102 is a third-party application 108 configured with the API 110 for facilitating interaction with the secure data management platform 101, the API 110 may retrieve the shared data 103 automatically. The API 110 then decrypts the shared data 103 based on a common key known by the primary data center 105 and the API 110.

It is noted that the above described approach limits the ability of a malicious attack upon the primary data center 105 of the provider by requestors 102 with a low level of trust. For example, the exchange between the requestor 102, the secure data management platform 101 and the primary data center 105 may be facilitated by way of various security based network protocols (e.g., Simple Network Management Protocol (SNMP)) and techniques. In addition, data transferred between the requestor 102 and the platform 101 is encrypted for transport, for example, by use of secure transport services such as secure sockets layer (SSL). Data transmitted over a secure connection cannot be tampered with or forged without the parties to the session, i.e., the platform 101 and the requestor 102, becoming immediately aware of the tampering.

Still further, the secure data management platform 101 may also authenticate the access point to which the requestor 102 is connected to the primary data center 105 via certification, for example, to ensure that the requestor 102 is connected to a valid access point. This may include usage of digital certificates for enabling secure, confidential communication between two parties using encryption. The certificate, by way of example, can perform the following functions: 1) identification of the requestor 102 as a trusted known entity; and 2) providing the requestor 102 with the certificate required to exchange information with the secure data management platform 101 for accessing the shared data 103.

By verifying the trust relationship in combination with strong encryption of all transmitted data via the look-up keys for proper decryption, the requestor 102 and primary data center 105 are able to maintain a high level of privacy and integrity.

In certain embodiments, usage of look-up key values as an index for storing and retrieving the actual sensitive data 106 corresponding to the request along with profile data 104 acts as a means of further security. With public-key cryptography, keys work in pairs of matched “public” and “private” keys. The private key is used by the secure data management platform 101, for example, to encrypt the shared data 103 passed to the requestor 102. The message can then be decrypted by the requestor 102 using the corresponding public key. Per this approach, those requests generated to present the proper key values may trigger accessing of the sensitive data 106 corresponding to the request. In addition, the profile data 104 may be processed by the secure data management platform 101 to identify criteria for determining the subset of data to be retrieved, wherein only sensitive data 106 most pertinent to the request is provided as shared data 103.

Additionally, consistent with the above described procedure, the requestor 102 only gains access to the shared data 103 required to fulfill the request via the secure data management platform 101. This is in contrast to direct interaction between the requestor 102 and the primary data center 105, particularly within the internal/private network of the provider of the data center 105. The platform 101 provides a seamless procedure. That is, the requestor 102 interacts with the secure data management platform 101 to receive the data as if the interaction was directly with the primary data center 105. Furthermore, the interaction is outside of the internal/private network of the provider of the data center 105, which further restricts the vulnerability of the sensitive data to attack. In this way, a hacker wishing to access the sensitive data 106 is limited to only the externally located shared data 103, rather than the entire privately maintained database 106.

In certain embodiments, the requestors 102, the secure data management platform 101 and other elements of system 100 may be configured to communicate via service provider network 111. In addition, the primary data center 105 may be a network system configured within the service provider network 111. For example, the primary data center 105 may be implemented as a centralized repository, either physical or virtual, for the storage, management and dissemination of sensitive data 106. As such, the primary data center 105 may house multiple computer systems, associated components and various other network elements such as telecommunications and storage systems that house the data 106. While shown as a single entity, it is noted that the sensitive data 106 may be distributed across multiple different repositories and locations of the primary data center 105 for maintaining different sensitive data 106 associated with the service provider network 111.

According to certain embodiments, one or more networks, such as data network 113, telephony network 115, and/or wireless network 117, can interact with the service provider network 111. Networks 111-117 may be any suitable wireline and/or wireless network, and be managed by one or more service providers. For example, telephony network 115 may include a circuit-switched network, such as the public switched telephone network (PSTN), an integrated services digital network (ISDN), a private branch exchange (PBX), or other like network.

Networks 111-117 may employ various technologies for enabling wireless communication including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Still further, the service provider network may embody circuit-switched and/or packet-switched networks that include facilities to provide for transport of circuit-switched and/or packet-based communications. It is further contemplated that networks 111-117 may include components and facilities to provide for signaling and/or bearer communications between the various components or facilities of system 100. In this manner, the communication network 111 may embody or include portions of a signaling system 7 (SS7) network, Internet protocol multimedia subsystem (IMS), or other suitable infrastructure to support control and signaling functions.

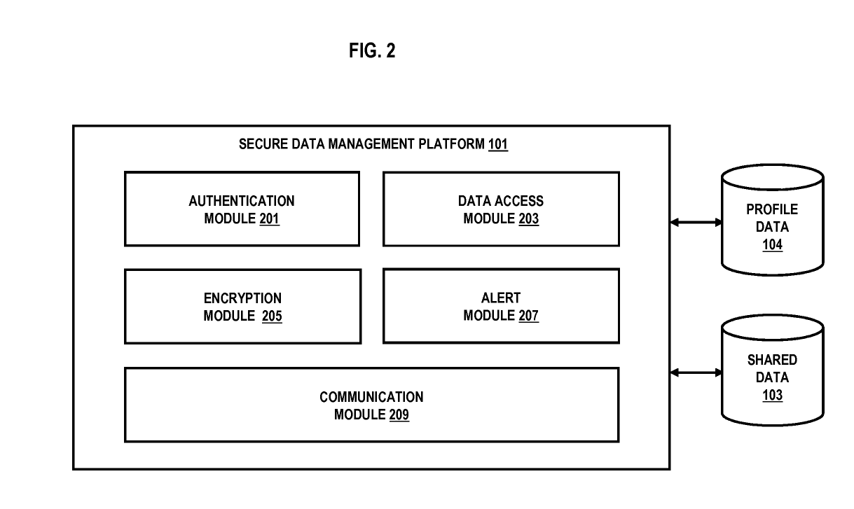

FIG. 2 is a diagram of the components of a secure data management platform 101, in accordance with one embodiment. The secure data management platform 101 includes various executable modules for performing one or more computing, data processing and network based instructions that in combination provide a means of enabling limited secure access to sensitive data by an authorized requestor. Such modules can be implemented in hardware, firmware, software, or a combination thereof. By way of example, the secure data management platform 101 may include an authentication module 201, data access module 203, encryption module 205, alert module 207 and communication module 209. In addition, the secure data management platform 101 also accesses profile data from a database 104 as well as maintains shared data in a database 103.

In one embodiment, an authentication module 201 authenticates users and user devices (which may be any one of clients 107a-107n) for interaction with the secure data management platform 101. By way of example, the authentication module 201 may facilitate provisioning of an API 110 for enabling the generation of requests for shared data 103. The provisioning may be based upon an initial setup procedure, wherein a digital certificate corresponding to the requestor 102 is established. In certain instances, one or more public keys may also be assigned to or associated with the requestor 102 to facilitate look-up key exchange accordingly. It is noted that the provisioning of the API 110 (e.g., any one or more of API 110a-110n) as well as any public keys may be performed securely between the requestor 102 and the authentication module 201 per the communication module 209.

Still further, the authentication module 201 may enable the establishment of various criteria and other settings for dictating the level of authority or access of the requestor 102 to the sensitive data 106 maintained by the primary data center 105. By way of example, the profile data 104 may be configured per a configuration file for indicating specific criteria for permissions, access rights, data access levels granted, etc. In addition, the profile data 104 may also store the digital certificate of the requestor 102 as well as enable passage of requests through an established firewall 120.

The authentication module 201 also receives a request from an API 110 of a requestor 102 to initiate a data access request. By way of example, the authentication module 201 may enable passage of the request to the data access module 203, which may facilitate the determining of whether a specified network element, resource, etc., of the primary data center 105 may be accessed per the request (e.g., per profile data 104). It is noted, therefore, that the authentication module 201 facilitates interaction between the secure data management platform 101 and the primary data center 105 within the context of the internal network of the provider of the data center 105.

In one embodiment, the data access module 203 operates in connection with authentication module 201 to enable key look-up. For example, the data access module 203 may validate the authenticity of a key submitted by the requestor 102 for accessing specific sensitive data 106. The data access module 203 may execute the key lookup according to any known and developing data security protocols and procedures.

In response to validation of the key by the data access module 203, the data access module 203 also initiates retrieval of the requested sensitive data 106. By way of example, the data access module 203 receives a subset of the sensitive data from the primary data center 105 corresponding to the nature of the request, the access privileges of the requestor 102, etc. The nature of the request, privileges, access rights and the like are determined by the data access module 203 per the profile data 104. The encryption module 205 then encrypts the subset of data and stores it in the shared database 103. Alternatively, the encryption module 205 may submit a request for the primary data center 105 to perform the encryption in response to the request for access to the sensitive data 106. Under this scenario, the subset of data stored to the shared data repository 103 is encrypted upon receipt by the data access module 203. It is further noted that encryption module 205 may enable requestors 102 to retrieve previously stored shared data 103.

In one embodiment, the alert module 207 generates an alert for indicating that the shared data 103 is available upon retrieval. As such, the alert module 207 provides notice to the requestor 102 that the shared data 103 is available, albeit a subset thereof (if applicable). In addition, the alert module 207 may initiate execution of the communication module 209, which facilitates transmission of the shared data 103 to the requestor 102 (e.g., according to a push data procedure). Alternatively, the alert module 207 may be activated on an as needed basis, such as in response to a request from a requestor 102 for the available shared data 104. Per this approach, the encryption module 202 may be called upon for supporting retrieval of previously stored (encrypted) shared data 104. In either scenario, it is noted that the communication module 209 may enable formation of a session between the requestor 102 as well as the primary data center 105 based on known security based protocols and exchange techniques. This may include, for example, secure sockets link (SSL) as well as simple network management protocol (SNMP).

The above presented modules and components of the secure data management platform 101 can be implemented in hardware, firmware, software, or a combination thereof. Though depicted as a separate entity in FIG. 1, it is contemplated that the platform 101 may be implemented for direct operation by respective requestors 102. For example, the platform 101 may be integrated within a client 107 for direct interaction with a third party application 108 that is accessed by the client 107.

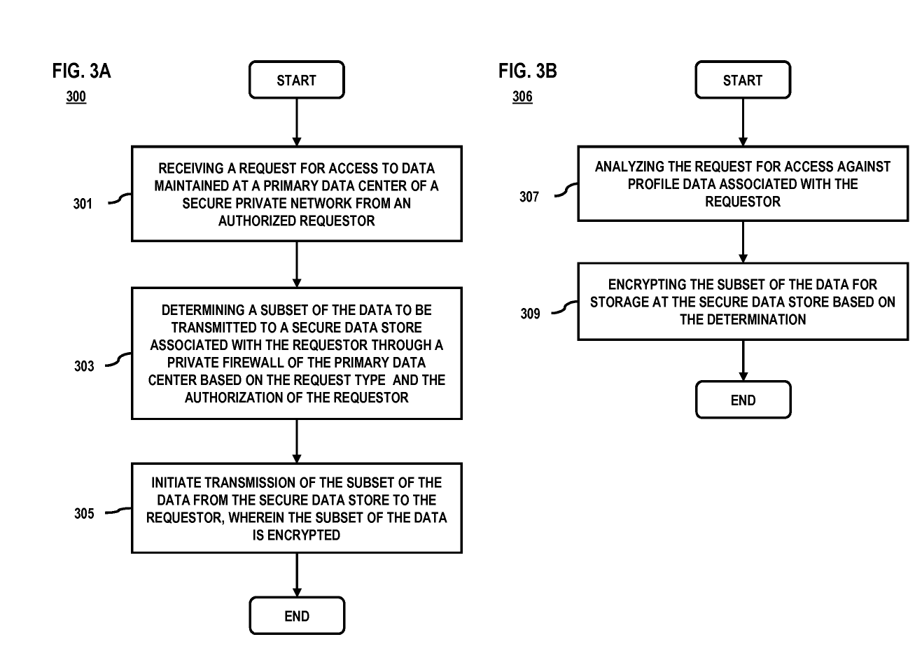

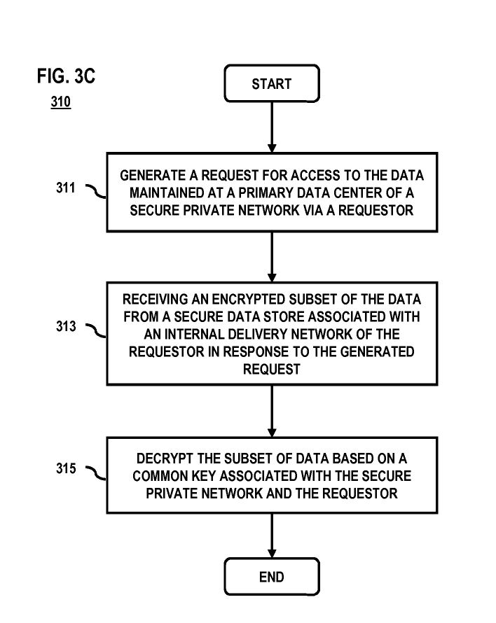

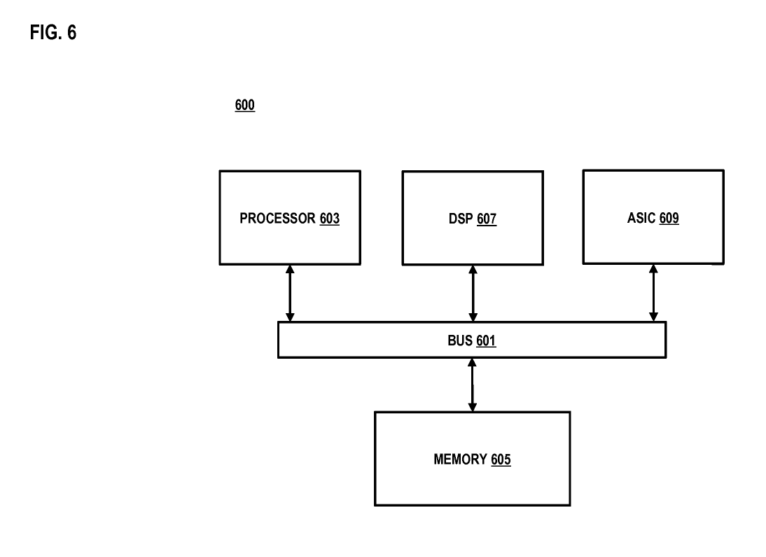

FIGS. 3A and 3B are flowcharts of processes for enabling limited secure access to sensitive data by an authorized requestor, in accordance with various exemplary embodiments. For the purpose of illustration, processes 300, 306 and 310 are described with respect to FIG. 1. It is noted that the steps of the processes 300, 306 and 310 may be performed in any suitable order, as well as combined or separated in any suitable manner. In one embodiment, the secure data management platform 101 performs processes 300 in conjunction with the primary data center 105. In another embodiment, the requestor 102 interacts with the secure data management platform 101 (e.g., via an application programming interface (API) 110). It is noted that the various processes may be executed, for instance, by way of a chip set including a processor and a memory as shown in FIG. 6.

In step 301 of process 300, the secure data management platform 101 and/or primary data center 105 receives a request for access to data maintained at the primary data center of a secure private network from an authorized requestor. As indicated above, the request may include a reference to a digital certificate of the requestor 102. Still further, the request may specify a data type, resource or network element to be accessed or a particular transaction/request type to be performed at the behest of the requestor. It is noted, therefore, that the request may be generated as a message corresponding to a known messaging protocol, wherein the message indicates one or more data fields and corresponding data values for indicating the requestor 102, the request type (e.g., transaction type, network element or resource type), the certificate, etc.

In another step 303, the secure data management platform 101 determines a subset of the data to be transmitted to a secure data store 103 associated with the requestor 102 through a private firewall 120 of the primary data center 105 based on the request type and the authorization of the requestor 102. This may include, for example, parsing the request message upon receipt and analyzing it against established profile data 104, such as to determine the nature of the request and the access rights granted the requestor 102. As mentioned previously, the requestor 102 that generates the request message may include an application programming interface, a third party application or service, a client device, or a combination thereof that is prevented from accessing the primary data center via the private firewall.

Per step 305, the secure data management platform 101 initiates transmission of the subset of the data from the secure data store (e.g., the shared data repository 105) to the requestor 102. As noted previously, the subset of data may be transmitted per a secure network protocol, such that the subset is transmitted in an encrypted form. It is noted that only a subset of sensitive data 106 may be ultimately retrieved from the primary data center 105 per the above described procedures. Under this scenario, the subset of data is made available to the requestor 102 as shared data 103, based on the nature of the request, access rights of the requestor 102, etc., as opposed to permitting unrestricted access to the sensitive data 106.

In step 307 of process 306 (FIG. 3B), the secure data management platform 101 analyzes the request for access against profile data associated with the requestor. As discussed previously, the secure data management platform 101 may access the profile data 104 corresponding to the requestor 102 to determine said permissions/rights accordingly. This may include, for example, comparing a request type value specified in the request against the profile data 104 of the requestor 102 to determine if the request type may be performed. As another example, a data type specified via the request may be compared against the profile data 104 to determine if the requestor is permitted access to the data. It is noted that the profile data 104 may be established at the time of registration or activation of the requestor 102 (e.g., API 110), wherein the authorization/access rights, certificates, etc., may be assigned by the provider of the primary data center 105.

In another step 309, the secure data management platform 101 encrypts a subset of the data for storage at the secure data store based on the determination (e.g., of the subset of data to be transmitted). As mentioned previously, the encryption of the subset of the data is performed using a common key associated with the secure private network and the requestor 102 (e.g., the application programming interface 110, client device 107, etc.). Also, the encryption may be performed within the secure private network (e.g., per the primary data center), an internal delivery network of the requestor 102, or a combination thereof. In the latter case, the secure data store for housing the subset of shared data 103 is accessed by the requestor 102 via the internal delivery network (and not the secure private network). Of note, the subset of data corresponds to only that which is pertinent to fulfillment of the request based on the request type, profile data 104 associated with the requestor 102 or the key information.

In step 311 of process 310 (FIG. 3B), the requestor 102 generates a request for access to the data maintained at a primary data center of a secure private network via a requestor (e.g., an application programming interface (API)). As noted previously, the requestor 102 may include an application programming interface, a third party application or service, a client device, or a combination thereof that requires access to or processing of the sensitive data. In another step 313, the requestor 102 receives an encrypted subset of the data from a secure data store associated with an internal delivery network of the requestor in response to the generated request. As noted previously, the subset of the data is determined based on a request type and the authorization of the requestor.

Per step 315, the requestor 102 decrypts the subset of data based on a common key associated with the secure private network and the application programming interface 110. Once decrypted, the subset of data may be utilized by the requestor 102 accordingly, such as to enable execution of the task for which the request was initiated.

It is noted that the above described procedures ensure that the sensitive data maintained at a primary data center is restricted to being accessed only by authorized requestors 102. Still further, the access is limited to only the most pertinent data for fulfilling the transaction request.

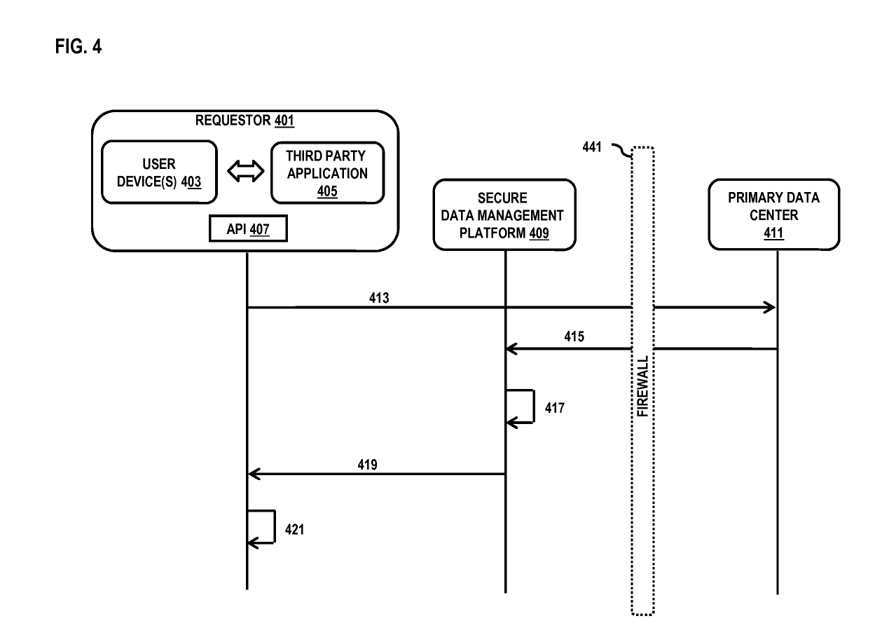

FIG. 4 depicts an exemplary system flow diagram illustrating data flow between a requestor and the secure data management platform for interacting with a primary data center, in accordance with one embodiment. For the purpose of illustration, the requestor 401 may include a user device 403 that executes a third party application 405 for generating a request. In addition, the requestor 401 may execute an application programming interface 407 that is configured to generate requests as well as interact with the secure data management platform 409.

In step 413, the requestor 401 submits a request for access to sensitive data to the primary data center 411. By way of example, the request may specify credentials for enabling the request to pass through a firewall 441 of the provider of the primary data center 411. This may include validating the level of access or authorization of the requestor 401 per profile data maintained for the requestor 401. In addition, the request may specify a look-up key value corresponding to the network element, data type, resource, data store, etc., to be accessed for fulfillment of the request.

It is noted that the request may be initially received by a server, node or other agent associated with the primary data center 411, i.e., an access point to a secure private network. This agent may then interact with the primary data center 411 to submit the request. Also, while implementation approaches may vary, it is noted that the requestor 401 may alternatively submit the request to the secure data management platform 409 (thus, enabling the secure data management platform 409 to serve as the agent). Under this approach, the secure data management platform 409 then transmits the request to the primary data center 411 accordingly.

In step 415, upon validating the requestor 401 and the look-up key, the primary data center 411 submits the sensitive data to the secure data management platform 409. Once received, the secure data management platform 409 encrypts the sensitive data and stores it as shared data per step 417. Alternatively (not shown), the sensitive data may be encrypted at the primary data center as initiated by the secure data management platform 409. By way of example, the encryption may be performed based on known encryption techniques and may be further based on a common look-up key associated with the secure private network and the application programming interface 407 of the requestor 401. The encryption may further include encoding of the data using known secure network protocols.

In step 419, the secure data management platform 409 initiates transmission of the encrypted shared data to the requestor 401. The secure data management platform 409 may first submit a notification signal to the requestor 401 to indicate availability of the shared data. Once received, the requestor 401 decrypts the encrypted shared data based on the common key, according to step 421. Decryption of the data indicates fulfillment of the request. It is noted the decryption may be performed by the requestor 401 via a decryption function of API 407. As such, the requestor 401 may retrieve previously stored shared data, wherein the decryption is based at least in part on the common look-up key.

The shared data representing the subset of data retrieved from the primary data center 411 is made available for access by the requestor 401 via the secure data management platform 409. Hence, the secure data management platform 409 provides a level of separation between the requestor 401 and the data housed in the primary data center 411. This is in contrast to direct submission of the sensitive data to the requestor 401 by the primary data center 411. By way of this approach, the accessibility of the primary data center 411 to exposure by unwarranted activity by the requestor 401 is limited. Furthermore, the internal delivery network of the requestor 401 and the secure private network of the primary data center 411 remain segregated while still enabling the availability of at least a subset of the sensitive data per the secure data management platform 409.

The processes described herein for enabling limited secure access to sensitive data by an authorized requestor may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

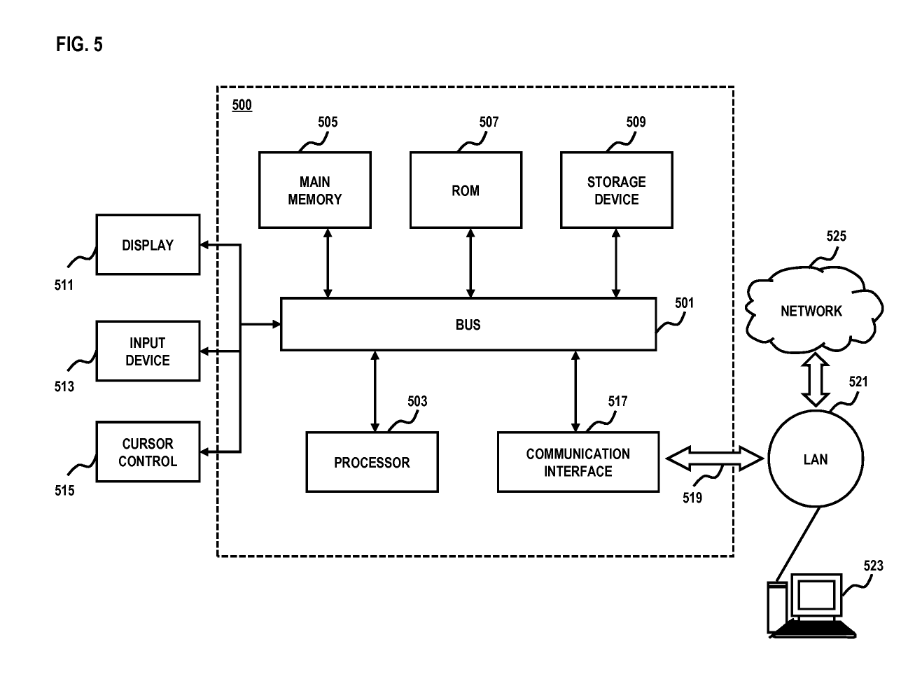

FIG. 5 is a diagram of a computer system that can be used to implement various embodiments. The computer system 500 includes a bus 501 or other communication mechanism for communicating information and one or more processors (of which one is shown) 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for adjusting cursor movement on the display 511.

According to an embodiment of the invention, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. Thus, embodiments of the invention are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an embodiment of the invention through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 6 illustrates a chip set or chip 600 upon which an embodiment may be implemented. Chip set 600 is programmed to enable limited secure access to sensitive data by an authorized requestor as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of enabling limited secure access to sensitive data by an authorized requestor.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to enable limited secure access to sensitive data by an authorized requestor. The memory 605 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a request for access to data maintained at a primary data center of a secure private network from an authorized requestor; and
determining a subset of the data to be transmitted to a secure data store associated with the requestor through a private firewall of the primary data center based on a request type and an authorization of the requestor.

2. A method of claim 1, further comprising:
initiating transmission of the subset of the data from the secure data store to the requestor,
wherein the subset of the data is encrypted.

3. A method of claim 1, further comprising:
analyzing the request for access against profile data associated with the requestor,
wherein the profile data specifies one or more request types, an authorization of the requestor, or a combination thereof.

4. A method of claim 1, further comprising:
encrypting the subset of the data for storage at the secure data store based on the determination,
wherein the encryption is performed using a common key associated with the primary data center and the requestor.

5. A method of claim 4, wherein the encryption is performed within the secure private network, an internal delivery network of the requestor, or a combination thereof.

6. A method of claim 5, wherein the secure data store is accessed by the requestor via the internal delivery network.

7. A method of claim 1, wherein the requestor includes an application programming interface, a third party application or service, a client device, or a combination thereof and the requestor is prevented from accessing the primary data center via the private firewall.

8. An apparatus comprising:
a processor; and
a memory including computer program code,
the memory and the computer program code configured to, with the processor, cause the apparatus to perform at least the following,
receive a request for access to data maintained at a primary data center of a secure private network from an authorized requestor,
determine a subset of the data to be transmitted to a secure data store associated with the requestor through a private firewall of the primary data center based on the request type and the authorization of the requestor.

9. An apparatus of claim 8, wherein the apparatus is further configured to:
initiate transmission of the subset of the data from the secure data store to the requestor,
wherein the subset of the data is encrypted.

10. An apparatus of claim 8, wherein the apparatus is further configured to:
analyze the request for access against profile data associated with the requestor,
wherein the profile data specifies one or more request types, an authorization of the requestor, or a combination thereof.

11. An apparatus of claim 8, wherein the apparatus is further configured to:
encrypt the subset of the data for storage at the secure data store based on the determination,
wherein the encryption is performed using a common key associated with the primary data center and the requestor.

12. An apparatus of claim 11, wherein the encryption is performed within the secure private network, an internal delivery network of the requestor, or a combination thereof.

13. An apparatus of claim 12, wherein the secure data store is accessed by the requestor via the internal delivery network.

14. An apparatus of claim 8, wherein the requestor includes an application programming interface, a third party application or service, a client device, or a combination thereof and the requestor is prevented from accessing the primary data center via the private firewall.

15. A method comprising:
generating a request for access to data maintained at a primary data center of a secure private network via a requestor; and
receiving an encrypted subset of the data from a secure data store associated with an internal delivery network of the requestor in response to the generated request,
wherein the requestor is prevented from accessing the primary data center through a private firewall associated with the primary data center.

16. A method of claim 15, further comprising:
decrypting the subset of data based on a common key associated with the secure private network and the requestor.

17. A method of claim 15, wherein the subset of the data is determined based on a request type and the authorization of the requestor.

18. A method of claim 15, wherein the requestor includes an application programming interface, a third party application or service, a client device, or a combination thereof.

19. A method of claim 15, wherein the encryption is performed within the secure private network, an internal delivery network of the requestor, or a combination thereof.

20. A method of claim 19, wherein the encryption is performed using a common key associated with the primary data center and the requestor.
